(19) United States
(12) Patent Application Publication
(10) Pub. No.: US 2006/0042803 A1
(43) Pub. Date: Mar. 2, 2006

(54) Sprinkler head shut-off tool

(75) Inventor: Dennis J. Gallaher, Liberty Center, OH (US)

Correspondence Address: PURDUE LAW OFFICES;2735 N. HOLLAND-SYLVANIA ROAD, SUITE B-2, TOLDEO, OH, 43615, US

(73) Assignee: Jeanette M. Gallaher

(21) Appl. No.: 11/067,242

(22) Filed: Feb. 25, 2005

Related U.S. Application Data
(60) Provisional application No. 60/605,745, filed on Aug. 31, 2004.

(51) Int. Cl. A62C 37/08

(52) U.S. Cl. 169/37

(57) ABSTRACT

A tool to stop the flow of water through an activated fire protection sprinkler head. This tool is designed to be a heavy duty, simple to operate mechanism capable of deactivating fire preventing sprinkler heads quickly. By simply turning the outer housing of the tool, by hand or by means of an adjustable extension pole, shut-off levers of this tool will be moved apart within the bracket of the sprinkler head until co-action between the bracket and one of the levers forces the other lever, preferably one bearing a shut-off gasket, against the open water orifice in the sprinkler head, thereby preventing the flow of water through it.

### BACKGROUND OF THE INVENTION

1. Field of the Invention

This invention is a tool for stopping the flow of water from an activated fire protection sprinkler head. More specifically, the invention is a tool with shut-off levers that can be actuated to stop the flow of water from an activated sprinkler head.

2. Description of the Prior Art

Automated fire protection sprinkler systems are in widespread use today around the world in buildings and on ships. The sprinkler heads in some such systems include an opening from which water can flow, a stopper which, in a first position, closes the sprinkler head and prevents the flow of water, and an actuator that is operable to keep the stopper in the first position. The actuator may be tripped, by fire or by accidental impact, for example, so that it becomes unable to keep the stopper in the first position whereupon the sprinkler head opens and water flows from the sprinkler head. In other systems, a body of a low-melting metal constitutes the stopper; similar problems can arise in these systems.

Open sprinkler heads are responsible for a great deal of water damage, whether the sprinkler heads are opened, as they are intended to be, by a fire situation or by accident. When a sprinkler head is opened, it is sometimes not possible to access a water valve that can be closed to stop the flow of water from the sprinkler head. In such a case, it is desirable to have means for stopping the flow of water from the sprinkler head. Wooden wedge-shaped blocks are commonly used for this purpose, but their deficiencies are numerous. Despite the efforts of numerous inventors in the field of fire protection sprinkler head shut-off devices, wooden blocks are still widely used. Thus, there exists a long felt need for an effective, easy to use tool for closing an open sprinkler head.

Accordingly, it is an object of the invention to provide a simple, reliable tool for closing an open sprinkler head.

It is a further object of the invention to provide a tool with two shut-off levers than can be actuated to move toward or away from one another by manipulation of a portion of the tool remote from the levers.

It is yet another object of the invention to provide such a tool that can be used with an extendable handle.

It is still a further object of the invention to provide such a tool that works with a sprinkler head in various different orientations.

These and other objects of the present invention will become clear from the following description, reference being made to the attached drawing figures.

### BRIEF DESCRIPTION OF THE DRAWING FIGURES AND PHOTOS

FIG. 1 is a perspective view of a tool according to the present invention with shut-off levers in a first, open position in which sealing gaskets on a first, upper shut-off lever and on a second, lower shut-off lever are not effective to prevent the flow of water from an associated sprinkler head.

FIG. 2 is a view in perspective of the tool shown in FIG. 1 with the shut-off levers in a second, open position in which they are effective to prevent the flow of water from the associated sprinkler head.

FIG. 3 is a vertical sectional view of the tool shown in FIGS. 1 and 2 with the sealing gaskets in the position shown in FIG. 2 where they are effective to prevent the flow of water from the associated sprinkler head.

FIG. 4 is a view in vertical section of the tool shown in FIGS. 1 and 2 with the sealing gaskets in the position shown in FIG. 1 where they are ineffective to prevent the flow of water from the associated sprinkler head.

FIG. 5 is an exploded view of the tool shown in FIGS. 1-4, showing details of its construction

### DETAILED DDESCRIPTION OF THE PREFERRED EMBODIMENTS

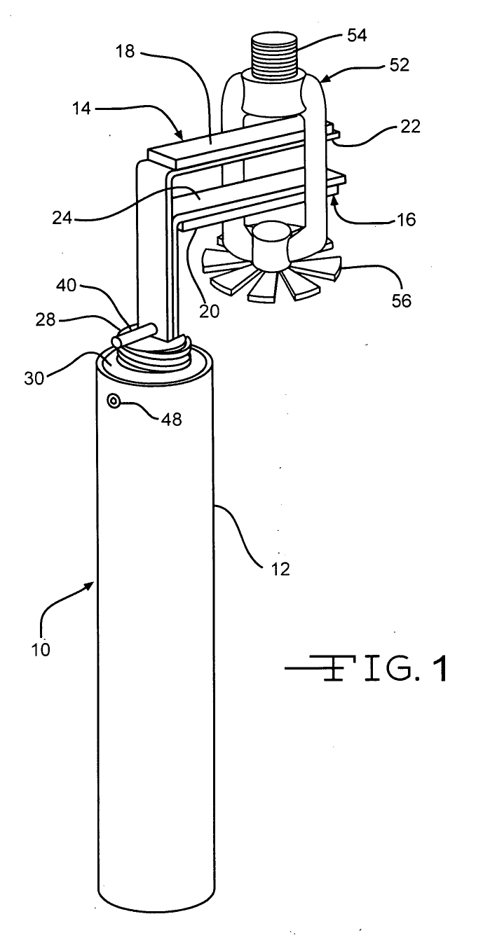

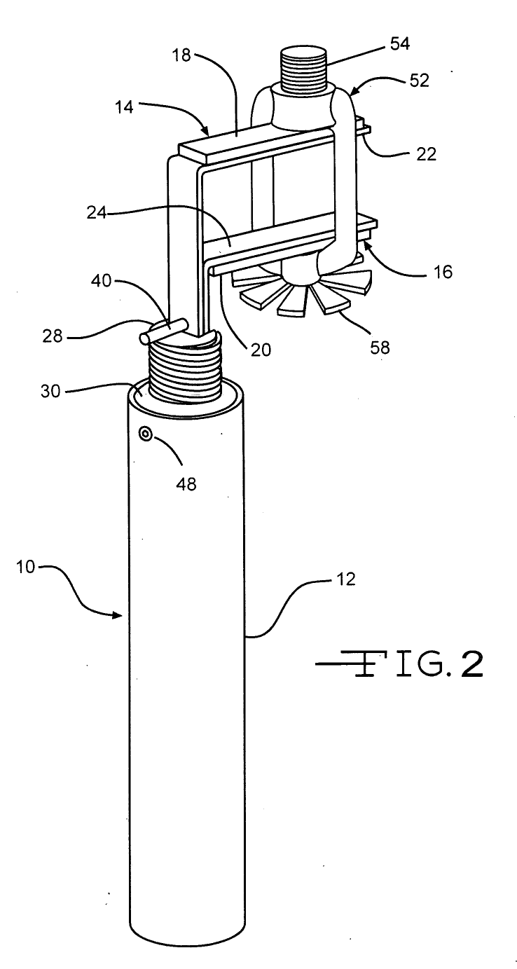

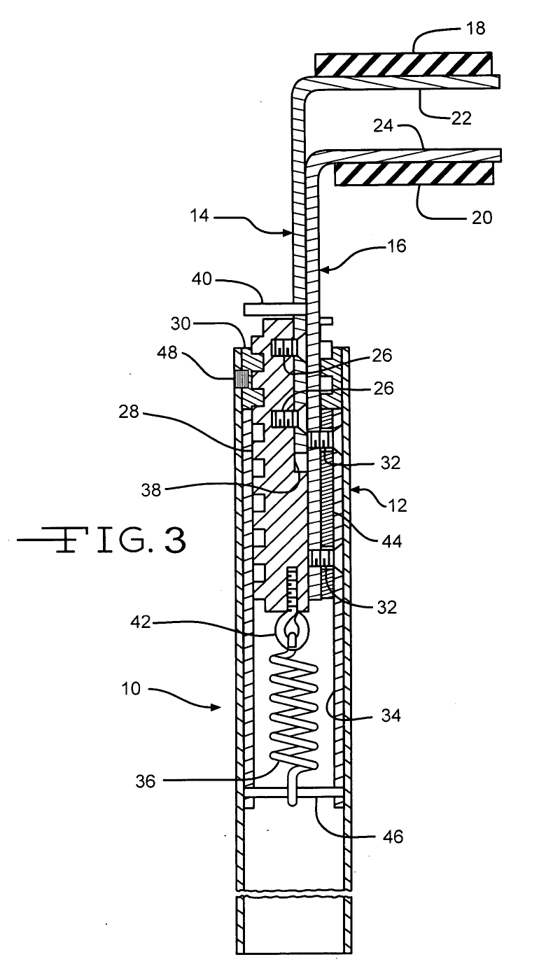

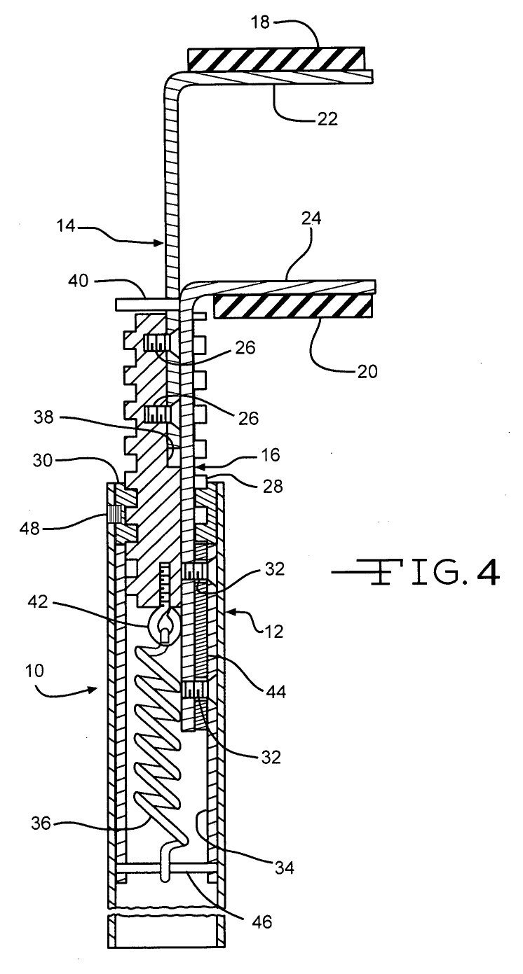

A tool according to the present invention is indicated generally at 10 in FIGS. 1 through 4. The tool 10 comprises an exterior tubular housing 12, a first, upper shut-off lever 14 and a second, lower shut-off lever 16. The shut-off levers 14 and 16 shown are L-shaped and a portion of each is within the housing 12 where, as explained below in more detail, there is a mechanism that is operable, when the housing 12 is rotated relative to the levers 14 and 16, to cause movement of one of the levers relative to the other between a first, closed position shown in FIGS. 2 and 4 and a second, open position shown in FIGS. 1 and 3. Shut-off gaskets 18 and 20 are adhesively or otherwise secured to and supported on angled ends 22 and 24 of the first shut-off lever 14 and of the second shut-off lever 16. Alternatively, the shut-off gaskets 18 and 20 can be adhesively secured to a sleeve (not shown) that can be slid onto and retained, frictionally or otherwise, on one or both of the angled ends 22 and 24. In a case where the tool 10 is to be used on a pendulum sprinkler head from below the sprinkler head, the gasket 18 is required and the gasket 20 is unnecessary. In a case where the tool 10 is to be used on an upright sprinkler head from below the sprinkler head, the gasket 20 is required and the gasket 18 is unnecessary.

As shown in FIGS. 3 and 4, the shut-off lever 14 of the tool 10 is attached by threaded fasteners 26 to an exteriorly threaded cylindrical bushing 28 which is threadedly received in an interiorly threaded insert 30 which is attached to the inside of the exterior tubular housing 12 of the tool 10. The shut-off lever 16 of the tool 12 is attached by threaded fasteners 32 to a sleeve 34 which is slidably received inside the housing 12, and urged by a spring 36 upwardly into contact with the threaded insert 30. Rotation of the housing 12 causes the insert 30 to rotate, and to move the bushing 28, and, with it, the lever 14, either upwardly or downwardly, depending upon the direction of rotation, relative to the housing 12. The sleeve 34, however, is urged by the spring 26 into contact with the insert 30 so that rotation of the housing 12 does not cause longitudinal movement of either the sleeve 34 or the lever 16 relative to the housing 12. The lever 14 can be moved, by rotation of the housing 12, between the position shown in FIGS. 2 and 4 and that shown in FIGS. 1 and 3, while the lever 16 remains in the same vertical position relative to the housing 12.

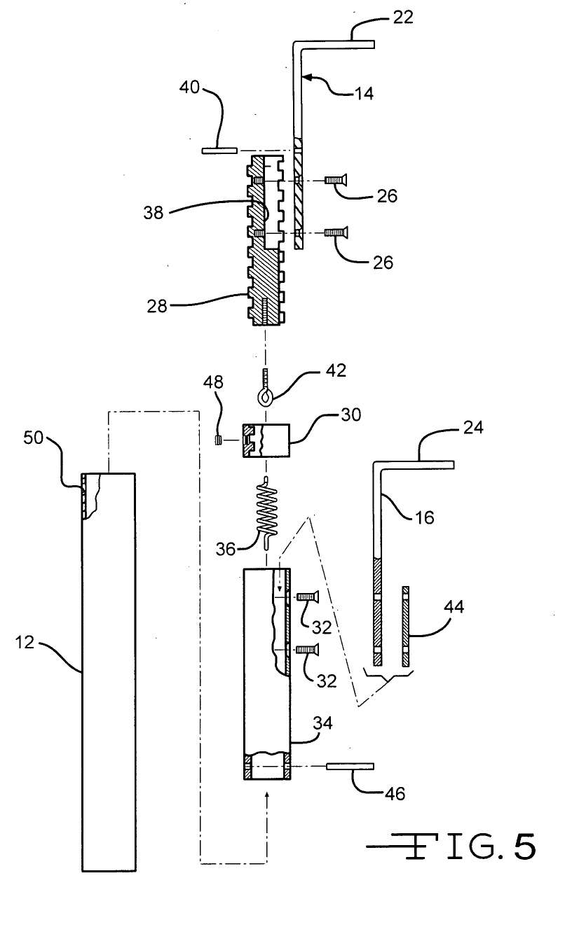

As shown in FIG. 5, there is a longitudinally extending slot 38 in the bushing 28 in which the shut-off lever 14 is received. The slot is stepped, as can be seen in FIGS. 3 and 4, with the deepest portion of the slot 38 receiving a portion of the shut-off lever 14. The first step in producing the tool 10 is to position the lever 14 in the deepest portion of the slot 38, and to attach it there with the fasteners 26. A stop 40 is then frictionally engaged in an opening in the lever 14, and an eye 42 is threaded into the bushing 28. Next, the insert 30 is threaded onto the bushing 28, and the lever 16 and a spacer 44 are attached to the sleeve 34, using the fasteners 32. The sleeve 34 is then slipped over the lower portion of the bushing 28 so that a portion of the lever 16 and the spacer 44 are received in the shallower portion of the slot 38, with the spring 36 attached between the eye 42 and a pin 46 which is inserted into the bottom of the sleeve 34. Finally, a set screw 48 is threaded into an opening 50 in the housing 12 to lock the insert 30 thereto.

The tool 10 is used to stop the flow of water from a sprinkler head, for example, flow that has been initiated by a fire but is no longer desired because the fire has been extinguished. The tool 10 is shown in FIG. 1 with the levers 14 and 16 in an “open” position, and the angled ends 22 and 24 inserted in a sprinkler head indicated generally at 52. The sprinkler head 52, known as a pendulum sprinkler head, is one in which, when it is in service, water flows downwardly through a nipple 54 to a nozzle, not shown, from which it is sprayed downwardly onto diffuser vanes 56 and then into a space below the sprinkler head 52 to extinguish a fire. Ordinarily, the flow of water is prevented by a fusible closure or by valving, but is initiated when the fusible closure is melted by a fire, or when valves are opened in response to a signal indicating that a fire has been sensed. After the fire has been extinguished, the tool 10 can be used to stop further flow of water and consequent damage, which can sometimes be extensive, by rotating the housing 12 to move the levers 14 and 16 from the relative positions shown in FIG. 1 to those shown in FIG. 2 where the shut-off gasket 18 prevents the flow of water through the nozzle of the sprinkler 52. Preferably, the threaded portions of the tool 10 are arranged so that when the housing 12 is rotated to move the levers to the closed position, the levers 14 and 16, caught in the sprinkler head 52, apply a torque to the sprinkler head that tends to tighten, rather than loosen, the sprinkler head in the fitting (not shown) in which it is mounted.

It will be appreciated that various changes and modifications can be made from the foregoing description of the invention without departing from the spirit and scope thereof as defined in the following claims. In its essential details, the invention is a tool for preventing the flow of water from the discharge opening of a nozzle of a sprinkler system. The tool comprises a tubular housing, two “L” shaped shut-off members having legs which are partially enclosed within and extend longitudinally of the housing and cross-members which are at least substantially parallel to each other and extend laterally of the housing, and a gasket on a surface of one of the cross-members. The tool is operable, when the housing is rotated, and portions of the legs are held captive in a sprinkler head, to cause relative longitudinal movement of the legs of the shut-off members to change the spacing between their cross-members. In a preferred embodiment, an externally threaded bushing which is enclosed within the housing is threadably engaged with the housing so that rotation of the housing causes longitudinal movement of the bushing relative to the housing. Most desirably, one of the shut-off members is structurally integral with the bushing.

In another preferred embodiment, the tool is operable, when the housing is rotated and portions of the shut-off members or legs are held captive in a sprinkler head, to cause longitudinal movement of the leg of one of the shut-off members, but is not operable to cause longitudinal movement of the leg of the other of the shut-off members. Preferably, the tool is operable to maintain one of the shut-off members in a substantially constant longitudinal position relative to the housing.

It will be appreciated that various changes and modifications are possible from the details of the invention as disclosed and described herein without departing from the spirit and scope of thereof.

I claim:

1. A tool for preventing the flow of water from the discharge opening of a nozzle of a sprinkler system, said tool comprising a tubular housing, two “L” shaped shut-off members having legs which are partially enclosed within and extend longitudinally of said housing and cross-members which are at least substantially parallel to each other and extend laterally of said housing, a gasket on a surface of one of said cross-members, and means enclosed within, and operable, upon rotation of said housing, to cause relative longitudinal movement of the legs of said shut-off members to change the spacing between the cross-members thereof.

2. A tool as claimed in claim 1 wherein said means enclosed within, and operable, upon rotation of said housing, to cause relative longitudinal movement of the legs of said shut-off members, includes an externally threaded bushing which is threadably engaged with said housing so that rotation of said housing causes longitudinal movement of said bushing relative to said housing.

3. A tool as claimed in claim 2 wherein one of said shut-off members is structurally integral with said bushing.

4. A tool as claimed in claim 1 wherein said means enclosed within, and operable, upon rotation of said housing, to cause relative longitudinal movement of the legs of said shut-off members includes means operable to maintain one of said shut-off members in a substantially constant longitudinal position relative to said housing.

5. A tool as claimed in claim 2 wherein said means enclosed within, and operable, upon rotation of said housing, to cause relative longitudinal movement of the legs of said shut-off members includes means operable to maintain one of said shut-off members in a substantially constant longitudinal position relative to said housing.

6. A tool as claimed in claim 3 wherein said means enclosed within, and operable, upon rotation of said housing, to cause relative longitudinal movement of the legs of said shut-off members includes means operable to maintain one of said shut-off members in a substantially constant longitudinal position relative to said housing.
